(19) United States
(12) Patent Application Publication
(10) Pub. No.: US 2024/0107186 A1
(43) Pub. Date: Mar. 28, 2024

(54) RGBIR CAMERA MODULE

(71) Applicant: Apple Inc., Cupertino, CA (US)

(72) Inventors: Hossein Sadeghi, San Jose, CA (US); Andrew T. Herrington, San Francisco, CA (US); Gilad Michael, Sunnyvale, CA (US); John L. Orlowski, Santa Clara, CA (US); Yazan Z. Alnahhas, Stanford, CA (US)

(21) Appl. No.: 18/372,047

(22) Filed: Sep. 22, 2023

Related U.S. Application Data
(60) Provisional application No. 63/409,621, filed on Sep. 23, 2022.

(51) Int. Cl. H04N 25/11; H04N 25/531; H04N 25/58; H04N 25/75

(52) U.S. Cl. CPC H04N 25/11; H04N 25/531; H04N 25/58; H04N 25/75

(57) ABSTRACT

Embodiments are disclosed for a single RGBIR camera module that is capable of imaging at both the visible and IR wavelengths. In some embodiments, a camera module comprises: an image sensor comprising: a microlens array; a color filter array (CFA) comprising a red filter, a blue filter, a green filter and at least one infrared (IR) filter; and a pixel array comprising pixels to convert light received through the color filter array into electrical signals; and an image signal processor (ISP) configured to: initiate capture of a first frame by reading signal pixels from the pixel array; initiate capture of a second frame by reading IR pixels from the pixel array; align the first and second frames; and extract the second frame from the first frame to generate a third enhanced frame.

### RELATED APPLICATION

This application claims the benefit of priority from U.S. Provisional Patent Application No. 63/409,621, filed Sep. 23, 2022, for “RGBIR Camera Module for Consumer Electronics,” which is incorporated by reference herein in its entirety.

### TECHNICAL FIELD

This application is directed to camera modules for consumer electronics.

### BACKGROUND

Some consumer products (e.g., smartphones, tablet computers) include two front Red Green Blue (RGB) camera modules and a separate infrared (IR) or near infrared (NIR) module. These modules take up a large footprint of consumer products which reduces usable screen area. Accordingly, it is desired to design a RGBIR camera module that is capable of imaging at both the visible and IR wavelengths to replace the RGB and IR camera modules.

### SUMMARY

Embodiments are disclosed for a RGBIR camera module that is capable of imaging at both the visible and IR wavelengths.

In some embodiments, a camera module comprises: an image sensor comprising: a micro lens array; a color filter array comprising a red filter, a blue filter, a green filter and at least one IR filter; and a pixel array comprising pixels to convert light received through the color filter array into electrical signals; and an image signal processor configured to: initiate capture of a first frame by reading signal pixels from the pixel array; initiate capture of a second frame by reading IR pixels from the pixel array; align the first and second frames; and extract the second frame from the first frame to generate a third enhanced frame.

In some embodiments, the second image is extracted from the first frame only when the ISP determines that the camera module is being operated outdoors or indoors where lighting has IR content.

In some embodiments, the ISP determines that the camera module is being operated outdoors based on a face identification receiver output or an ambient light sensor with IR channels.

In some embodiments, output of an ambient light sensor is used to identify indoor IR noise.

In some embodiments, the image sensor is a rolling shutter image sensor.

In some embodiments, the image sensor is running in a secondary inter-frame readout (SIFR) mode.

In some embodiments, the first frame is captured with a first exposure time and the second frame is captured with a second exposure time that is shorter than the first exposure time.

In some embodiments, the second frame is captured while operating in an IR flood mode.

In some embodiments, a camera module comprises: an image sensor comprising: a microlens array; a color filter array comprising a red filter, a blue filter, a green filter and at least one IR filter; and a pixel array comprising pixels to convert light received through the color filter array into electrical signals; and an image signal processor (ISP) configured to: initiate capture of a first frame by reading signal pixels from the pixel array; initiate capture of a second frame by reading IR pixels from the pixel array; and generating virtual frames to fill in missing frames during up sampling of the first frame.

In some embodiments, the image sensor is running in an adaptive frame rate exposure mode when the virtual frames are generated.

In some embodiments, when operating in the adaptive frame rate exposure mode, signal pixel and IR pixel data are time-multiplexed and configured to be read at different frames and exposure times.

In some embodiments, a method comprises: capturing, with an image sensor, a first frame of a user's face by reading image pixels from a pixel array of the image sensor; capturing, with the image sensor, a second frame by reading infrared pixels from the pixel array; and extracting the second frame from the first frame to generate a third frame of the user's face.

In some embodiments, the method further comprises authenticating the user based at least in part on the enhanced third frame of the user's face.

In some embodiments, the extracting is only performed outdoors.

In some embodiments, the second image is captured using a rolling shutter pixel architecture.

In some embodiments, the second frame is captured while operating in an IR flood mode.

In some embodiments, a method comprises: capturing, with an image sensor, a first frame by reading image pixels from a pixel array of the image sensor; capturing, with the image sensor, a second frame by reading infrared pixels from the pixel array; and generating virtual frames to fill in missing frames during up sampling of the first frame.

In some embodiments, the image sensor is running in an adaptive frame rate exposure mode when the virtual frames are calculated.

In some embodiments, when operating in the adaptive frame rate exposure mode, signal pixel and IR pixel data are time-multiplexed and configured to be read at different frames and exposure times.

The advantages of the disclosed RGBIR camera module include but are not limited to a reduced screen notch size and footprint for the cameras, reduced cost, enhanced face identification outdoors and low-light image enhancement.

### BRIEF DESCRIPTION OF DRAWINGS

FIG. 1 is a conceptual system overview of a RGBIR camera module, according to one or more embodiments.

FIG. 2 illustrates using the RGBIR camera module of FIG. 1 for enhanced outdoor face identification, according to one or more embodiments.

FIG. 3 illustrates using the RGBIR camera module of FIG. 1 for low light image enhancement, according to one or more embodiments.

FIG. 4 is a schematic diagram of a rolling shutter (RS) image sensor, according to one or more embodiments.

FIG. 5 is a block diagram illustrating an overlapped exposure readout process, according to one or more embodiments.

FIG. 6 is a flow diagram of a sequential readout process, where RGB frame and IR frame exposures are separated in time, according to one or more embodiments.

FIG. 7 is a flow diagram of a process for reading out multiple IR frames during RGB exposure, according to one or more embodiments.

FIG. 8 illustrates modes of operation of the RGBIR camera module of FIG. 1, according to one or more embodiments.

FIG. 9 is a schematic diagram of a global shutter (GS) image sensor, according to one or more embodiments.

FIG. 10 is a block diagram of a GS pixel readout system, according to one or more embodiments.

FIG. 11 is a flow diagram of a process of combined readout of an RGB frame and IR frame in a single exposure, according to one or more embodiments.

FIG. 12 is a flow diagram of a process of combined readout of an RGB frame in a single exposure and multiple IR frame exposures, according to one or more embodiments.

FIG. 13 is a flow diagram of an enhanced face ID process using the RGBIR camera module of FIG. 1, according to one or more embodiments

FIG. 14 is a flow diagram of a low light image enhancement process using the RGBIR camera module of FIG. 1, according to one or more embodiments.

### DETAILED DESCRIPTION

### RGBIR Camera Module Overview

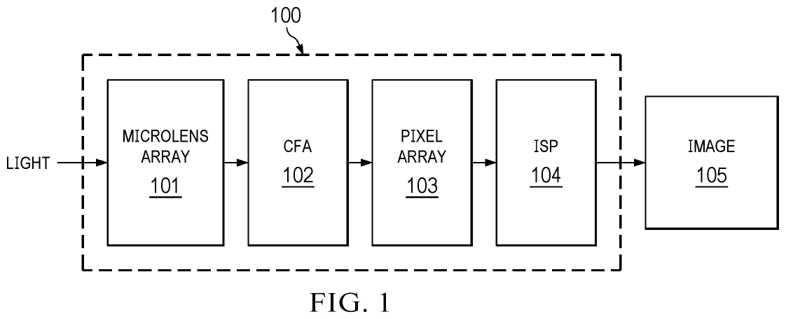

FIG. 1 is a conceptual overview of RGBIR camera module 100, according to one or more embodiments. RGBIR camera module 100 includes microlens array (MLA) 101, color filter array (CFA) 102, pixel array 103 and image signal processor (ISP) 104. MLA 101, CFA 102 and pixel array 103 collectively form an image sensor. Two examples of image sensors are a charge coupled device (CCD) image sensor and a complementary metal-oxide semiconductor (CMOS) image sensor.

MLA 101 is formed on CFA 102 to enhance light gathering power of the image sensor and improve its sensitivity. In some embodiments, CFA 102 is a 2×2 cell that includes one red filter, one blue filter, one green filter and one IR filter. In other embodiments, CFA 102 is a 4×4 cell where one out of 16 pixels is an IR pixel. In general, CFA 102 can be an n×n cell with one or more pixels being an IR pixel. Note that references throughout this description to “IR” should be interpreted to include both “IR” and “NIR,” but will be referred to as “IR” through the description, figures and claims.

Pixel array 103 includes a grid of photodiodes (“pixels”) that converts light received through the color filter array (CFA) into voltages that are integrated and readout by readout circuitry.

In a typical image sensor that includes CFA 102 with its filters arranged in a Bayer pattern, half of the total number of pixels in pixel array 103 are assigned to green (G), while a quarter of the total number of pixels is assigned to both red (R) and blue (B). When pixel array 103 is read out by ISP 104, line by line, the pixel sequence comes out as GRGRGR, etc., and then the alternate line sequence is BGBGBG, referred to as sequential RGB (or sRGB). Since each pixel is sensitive only to one color (one spectral band), the overall sensitivity of a color image sensor is lower than a monochrome (panchromatic) image sensor. As a result, monochrome image sensors are better for low-light applications, such as security cameras. The photons of light passthrough CFA 102 and impinge on the pixels in pixel array 103. The pixels are readout by readout circuitry for further processing by ISP 104 into final image 105.

The disclosed embodiments replace some of the pixels in a Bayer CFA 102 with IR pixels that are tuned to work at different wavelengths (e.g., 940 nm) than RGB pixels. Different IR pixel density and configurations in CFA 102 can be implemented depending on the application. In some embodiments, a back-illuminated image sensor and MLA 101 are used to optimize quantum efficiency at different wavelengths and to minimize RGB/IR crosstalk. In some embodiments, a dual bandpass filter is inserted in the light path (e.g., in the lens stack) to only pass light in a visible range and a target wavelength (e.g., 940 nm). In some embodiments, MLA 101 is configured/arranged to focus both visible and IR light on pixel array 103, and a coating technique applied to MLA 101 optimizes lens transmission in the desired frequency range. In some embodiments, sensor internal architecture is designed to minimize RGB-IR cross-talk to achieve high image quality.

ISP 104 is configured to capture an RGB frame by reading out RGB “pixels” from pixel array 103. ISP 103 also captures an IR frame by reading out IR pixels from pixel array 103. ISP 104 extracts the IR frame from the RGB frame to generate the final image 105. In some embodiments, machine learning (ML) techniques are implemented in ISP 104 to recover lost RGB information (e.g., recover modulation transfer function (MTF) or cross-talk correction) due to less green pixels in CFA 102, and thus restore quality to final image 105.

### Example Enhanced Outdoor Face Identification Application

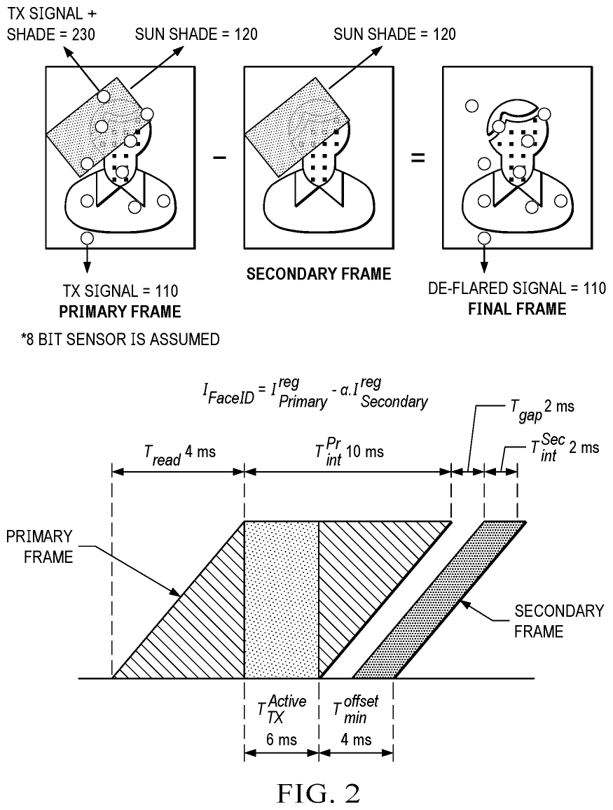

FIG. 2 illustrates using RGBIR camera module 100 for enhanced outdoor face identification (ID), according to one or more embodiments. An example of face identification technology is Apple Inc.'s FACE ID® available on the iPhone®. FACE ID® uses a depth sensor camera to capture accurate face data by projecting and analyzing thousands of invisible dots to create a depth map of a user's face and also captures an IR image of the user's face. A neural engine transforms the depth map and infrared image into a mathematical representation of the user's face and compares that representation to enrolled facial data to authenticate the user.

A global shutter (GS) IR camera is historically used in RGB cameras embedded in smartphones for robust outdoor performance to minimize the effect of sunshade or flare. In some embodiments, a rolling shutter IR image sensor is enabled for face identification by reading only IR pixels of pixel array 103 and running RGBIR camera module 100 in secondary inter-frame readout (SIFR) mode. A two-step process is used to measure and then extract the sunshade/flare in the face ID image.

Referring to FIG. 2, a first frame (primary frame) captures an image of the subject with the sunshade/flare and a second frame (secondary frame) captures a short exposure IR image that is used to capture the sunshade/flare. In some embodiments, a face ID transmitter (TX) active frame is captured that is a pseudo-global shutter frame with the face ID TX active only during common row exposure. A final frame is generated by extracting a registered (aligned) second frame (I_{Secondary}^{reg}) from a registered (aligned) first frame (I_{Primary}^{reg}), resulting in a final, enhanced face ID frame (I_{FaceID}) with background flare removed as shown in Equation [1]:

I_{FaceID}=I_{Primary}^{reg}−αI_{Secondary}^{reg}, [1]

where α is a correction factor to account for image intensity difference due to different exposure times.

As described above, image registration (image alignment) techniques are used for proper extraction or fusion of the second frame from/with the first frame. Since image extraction increases shot noise, in some embodiments RGBIR camera module 100 operates in two different indoor/outdoor modes with subtraction active only when in outdoor mode.

In some embodiments, the face ID RX is used to determine if RGBIR camera module 100 is outdoors or indoors where lighting has IR content (e.g., Tungsten light). For example, an ambient light sensor (ALS) embedded in RGBIR camera module 100, or in a host device housing the RGBIR camera module 101 (e.g., an ALS embedded in a smartphone) can be used to identify indoor. This technique could be used in two-dimensional (2D) imaging with IR flood lighting or three-dimensional (3D) imaging with a dot projector. The example timeline shown in FIG. 2 illustrates a readout out time (T_{read}) of about 4 ms, followed by an integration time (Tᵢₙₜ^{Pr}) of about 10 ms for the primary image signal, followed by a 2 ms time gap (T_{gap}), followed by an integration time (Tᵢₙₜ^{Sec}) of 2 ms for the secondary image signal. Note that the Face ID Tx is active for 6 ms during common row exposure and deactivated for a 4 ms minimum offset time (Tₘᵢₙ^{offset}). It is desirable in this embodiment to keep the time gap as short as possible to reduce image registration error.

### Example Low Light Image Enhancement Application

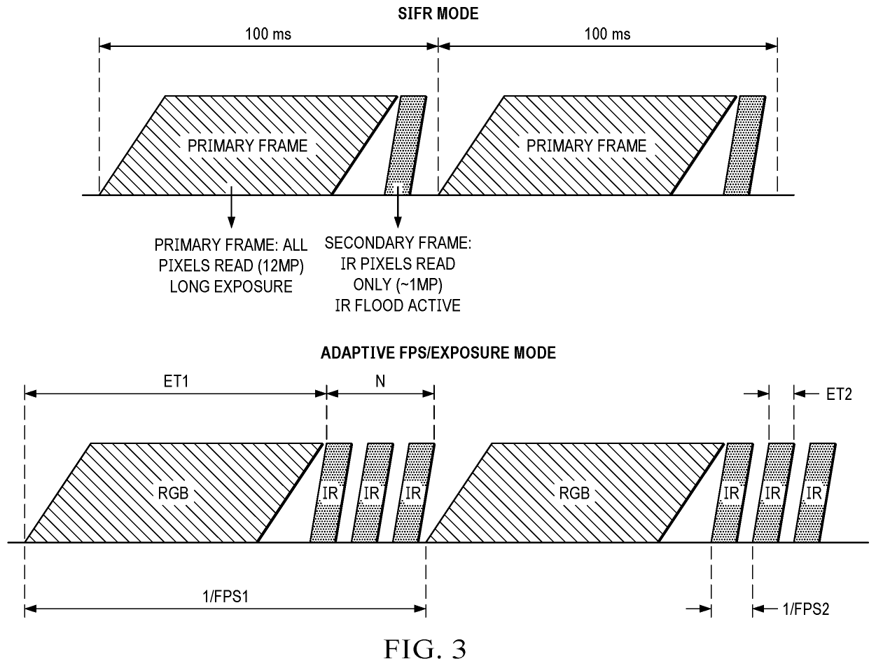

FIG. 3 illustrates RGBIR camera module 100 for low light image enhancement, according to one or more embodiments. When operating in low light conditions, the image sensor reads an RGB frame at a lower frame rate (e.g., 10 fps) in SIFR mode when the RGB frame has long exposure time to achieve high SNR, and the image sensor reads an IR frame while the TX IR flood is active. Virtual RGB frames are then interpolated to fill in the missing RGB frames to up sample high SNR low light frames from 10 fps to 30 fps, for example.

In some embodiments, the IR frame is used to calculate optical flow motion vectors in the RGB frame which are used to interpolate virtual RGB frames. Other frame interpolation techniques may also be used. To have a more accurate estimate of optical flow motion vectors, in some embodiments RGBIR camera module 100 is run in an adaptive frame rate/exposure mode. In adaptive frame rate/exposure mode, RGB and IR pixels are time-multiplexed and configured to be read at different frame rates (frames per second 1 (FPS1) and frames per second 2 (FPS2)) and different exposure times (exposure time 1 (ET1) and exposure time 2 (ET2)) as shown in FIG. 3. The number of IR frame captures between RGB frames is configured to achieve higher frame interpolation accuracy. The image sensor in RGBIR camera module 100 is capable of binning only IR pixels for application where less IR resolution and higher SNR is required. Pixel array 103 has a faster readout time for IR pixels than RGB pixels due to a fewer number of IR pixels to be read out. In some embodiments, the faster readout time is achieved by increasing the number of analog-to-digital converters (ADCs) in pixel array 103.

### Other Example Applications

Enhanced low light performance is critical for laptops and tablet computers since most use cases are indoor under low light conditions. Other applications include adding an RGBIR camera module 100 with a flood illuminator to a laptop or other device for enhanced low light performance, such as, for example, presence detection where the screen wakes up when the user is present in front of the RGBIR camera module 100. In presence detection mode, only IR pixels are read while IR flood is active and the RGBIR camera module 100 runs at low rate until motion is detected (to reduce power consumption), then high-rate mode is enabled to detect the user's face using face ID.

Another application for the RGBIR camera module 100 is for Chrysalis (camera behind display), where two RGBIR camera modules 100 are used instead of two RGB camera modules. The RGB and IR pixel patterns of the two RGBIR camera modules 100 are configured such that the RGB and IR pixels provide complementary missing information for the other RGBIR camera module.

In another application, an IR illuminator is used to create a stereo depth map using IR frames which can be used with the RGB frame for face ID to cover a range of lighting conditions (e.g., outdoor, low light, etc.) as complementary techniques. If one method falls short, pairs of RGB and IR frames from each RGBIR camera module 100 can be used for independent stereo depth measurements. In some embodiments, stereo depth from RGB pixels (with passive light) and IR pixels (with active IR flood) are fused together for improved depth accuracy, and which removes the need for a dot projector.

### Example Rolling Shutter Timing

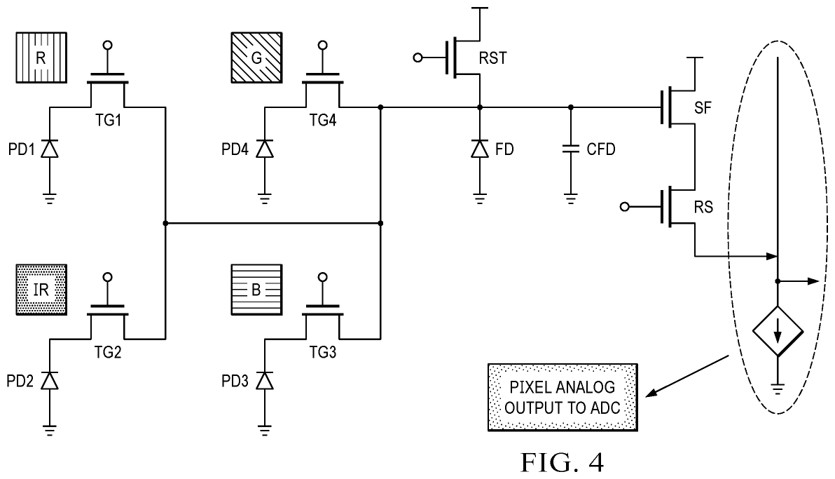

FIG. 4 is a schematic diagram of a rolling shutter (RS) CMOS image sensor, according to one or more embodiments. The RS CMOS image sensor features one ADC for each column of pixels, making conversion time significantly faster and allowing the CMOS cameras to benefit from greater speed. To further maximize speed and frame rates, each individual row of pixels on the image sensor begins the next frame's exposure after completing the readout for the previous frame. This is the rolling shutter, which makes CMOS cameras fast, but with a time delay/offset between each row of the image and an overlapping exposure between frames.

In this example embodiment, the image sensor includes a 4T pixel architecture. The 4T pixel architecture includes 4 pinned photodiodes (PD1, PD2 PD3, PD4), a reset transistor (RST), and transfer gates (TG1, TG2, TG3, TG4) to move charge from the photodiodes to a floating diffusion (FD) sense node (capacitance sensing), a source follower (SF) amplifier, and a row select (RS) transistor. The pixel analog voltage of the circuit is output to an ADC so that it can be further processed in the digital domain by ISP 104. Note that transfer photodiode PD2 and transfer gate TG2 are used for IR frame readout and the remaining photodiodes (PD1, PD3, PD4) and transfer gates (TG1, TG3, TG4) are used for RGB frame readout.

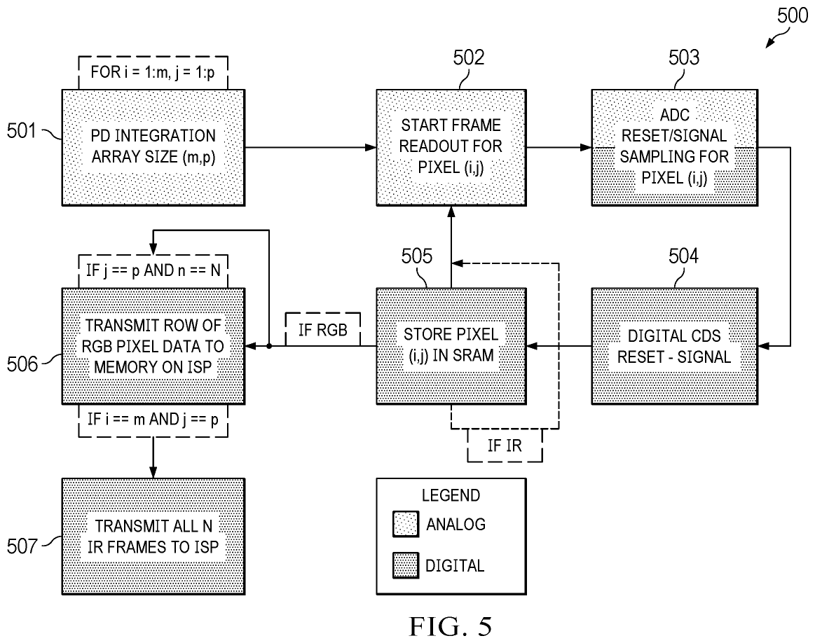

FIG. 5 is a block diagram illustrating overlapped exposure readout process 500, according to one or more embodiments. In the example shown, process 500 starts with photodiode integration 501 in the analog domain on pixel array 103 of size is (m, p), where m is the number of rows and p is the number of columns of pixel array 103. After integration, each pixel (i, j) voltage is readout 502 and sampled 503 by an ADC which outputs a digital representation of the pixel voltage, where i and j are row and column indices, respectively. In some embodiments, the pixel voltages are processed using correlated double sampling (CDS) 504 in the digital domain, which measures both an offset and a signal level and subtracts the two to obtain an accurate pixel voltage measurement. The digital representations of the pixel voltages are stored in memory 505 (e.g., stored in SRAM). For RGB frames, rows of pixel data are transferred 506 to memory on ISP 104 until the entire RGB frame is transferred 506 to ISP 104. After the entire RGB frame is transferred 507 to ISP 104, the IR frame is transferred to ISP 104 where it is subtracted from the RGB frame.

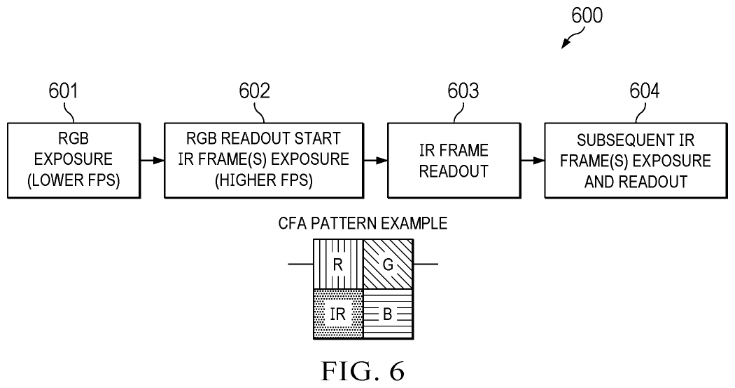

FIG. 6 is a flow diagram of a sequential readout process 600, where RGB and IR frame exposures are separated in time, according to one or more embodiments. Sequential readout process 600 begins with RGB frame exposure 601 at FPS1. Next the RGB pixels are readout and at the same time IR frame exposure starts at FPS2 602, which is a higher frame rate than FPS1. IR pixels are readout 603, followed by optional subsequent IR frame exposures and readout 604.

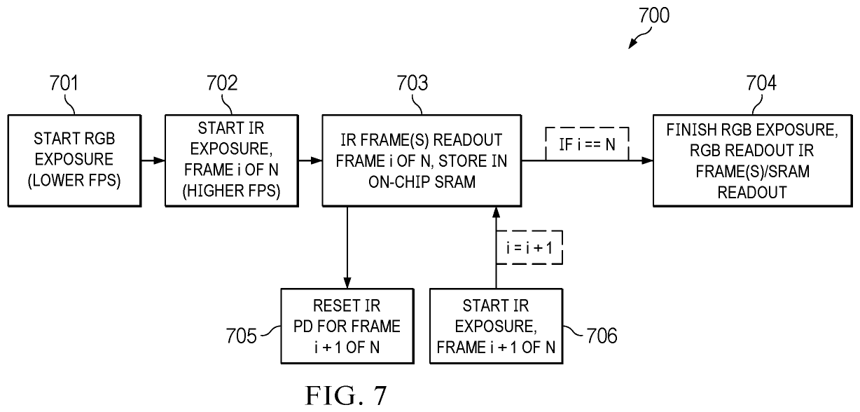

FIG. 7 is a flow diagram of a process 700 for reading out multiple IR frames during RGB frame exposure, according to one or more embodiments. RGB frame exposure starts 701 at FPS1 and IR frame exposure 702 of frame i (of N frames) starts during RGB frame exposure at FPS2, where FPS2 is higher than FPS1. IR frames i of N are readout and stored in memory 703. If all IR frames are readout, at step 704 RGB frame exposure is completed, RGB readout is performed, and the IR frames stored in SRAM are readout. Otherwise, the IR photodiodes for frame 1+1 of N are reset 705 and exposed again 706.

Note that in the process described above the IR/RGB channel overflows through the transfer gate into the floating diffusing sense node during RGB exposure time when the PDs become saturated, thus eliminating the need for an anti-blooming transistor. Additionally, the transfer gate behaves as a shutter gate to reset the RGB and IR photodiodes prior to the start of the exposure.

### Example RGBIR Modes of Operation

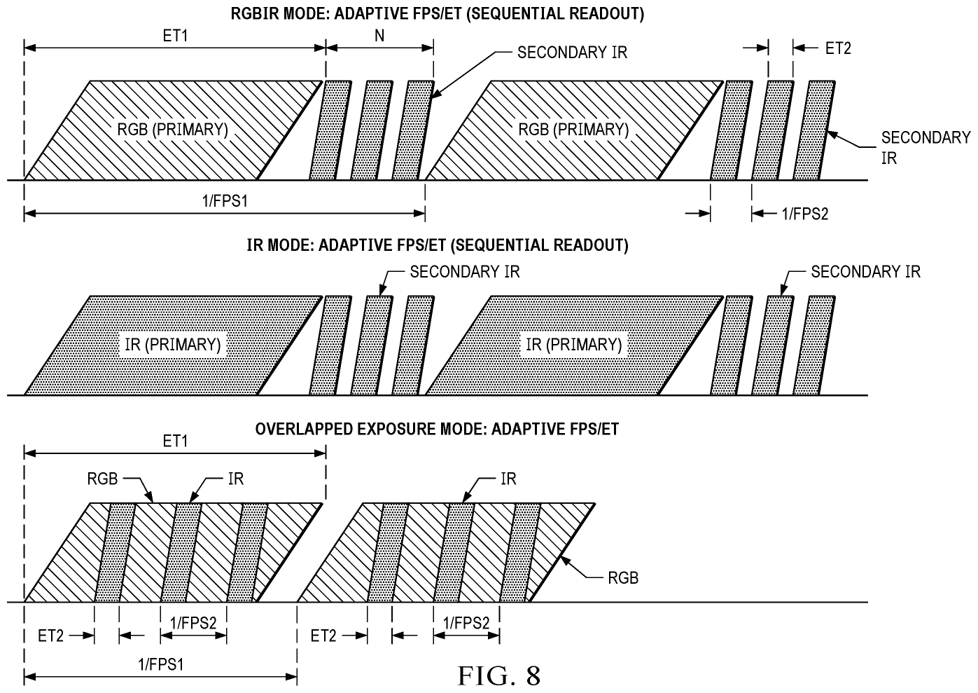

FIG. 8 illustrates 3 modes of operation of the RGBIR camera module 100 of FIG. 1, according to one or more embodiments. The first example timing diagram illustrates sequential readout in RGBIR mode, the second example timing diagram illustrates sequential readout in IR mode, and the third example timing diagram illustrates overlapped exposure mode.

In RGBIR mode, a primary RGB frame is exposed for ET1 and readout at FPS1, followed by N secondary IR frames at FPS2, where N=3 in this example. This pattern is repeated as shown in FIG. 8.

In IR mode, a primary IR frame is exposed for ET1 and readout at FPS2, followed by N secondary IR exposures and readouts (N=3 in this example). This pattern is repeated as shown in FIG. 8.

In overlapped exposure mode, a primary RGB frame is exposed, and while the RGB frame is exposed N secondary IR frames are exposed and readout. After the IR frames are readout, the RGB frame exposure completes and the RGB frame is readout. This pattern is repeated as shown in FIG. 8.

### Example Voltage Domain Global Shutter Timing

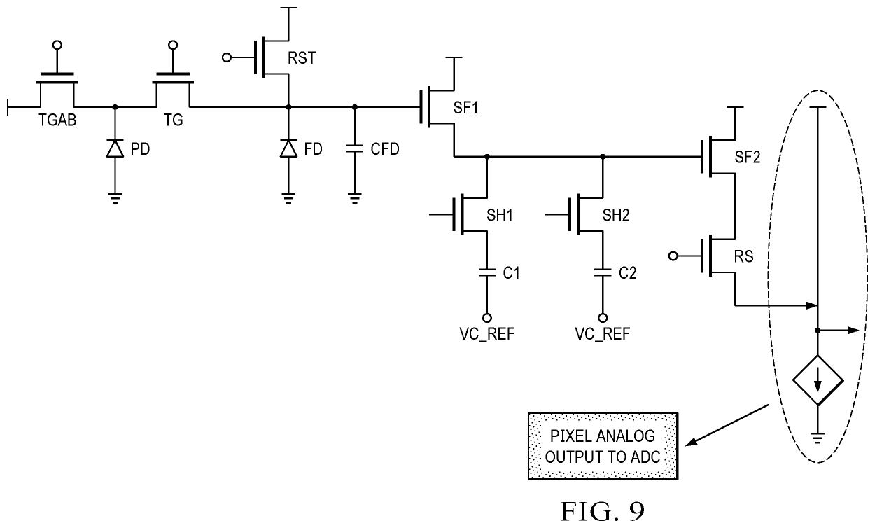

FIG. 9 is schematic diagram of a global shutter (GS) image sensor, according to one or more embodiments. A GS image sensor allows all the pixels to start exposing and stop exposing simultaneously for an exposure time for a frame. After the end of the exposure time, pixel data readout begins and proceeds row by row until all pixel data has been read.

The GS image sensor includes pinned photodiode (PD), shutter gate (TGAB), transmit gate (TG), floating diffusion (FD) sense node (capacitance sensing), FD capacitor (CFD), source follower amplifiers SF1, SF2, reset (RST) transistor and sample and hold circuits comprising SH1, SH2 transistors coupled to capacitors C1, C2, each of which are also coupled to a reference voltage (VC_REF). Additionally, there is a row select (RS) transistor for reading out rows of the pixel array. The capacitors store the reset and signal samples from SH1, SH2 transistors for each exposure. For multiple exposures, an additional capacitor is needed, e.g., for three exposures, four in-pixel capacitors are required. Only one capacitor is needed for reset sampling to achieve CDS as the storage time on all capacitors is equal. Note that there is no transistor sharing between pixels for voltage domain GS. Sequential/combined readout is supported. This allows for independent global control signals to pixel transistors which separates IR and RGB exposure times.

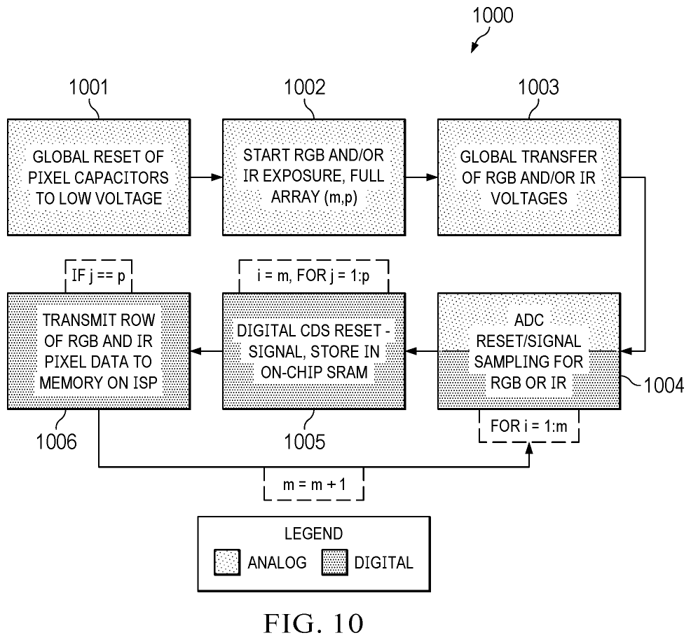

FIG. 10 is a block diagram of a GS pixel readout system 1000, according to one or more embodiments. System 1000 starts with a global reset of pixel capacitors to a low voltage 1001, after which time RGB and/or IR frame exposure starts on full pixel array (m, p) 1002, where m is rows and p is columns of the pixel array (m, p). After frame exposure, the full pixel array of RGB and/or IR voltages are transferred 1003 to an ADC. The ADC samples each row of the RGB frame or IR frame 1004. In some embodiments, CDS is performed on the samples 1005, and the results are stored in memory (e.g., SRAM). Each row of the RGB and IR pixel data is transferred 1006 to memory on ISP 103.

### Example Processes

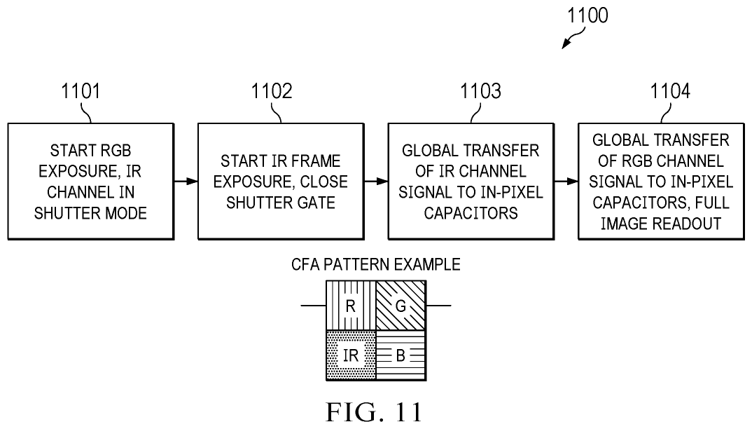

FIG. 11 is a flow diagram of a process 1100 for combined readout of an RGB frame and IR single frame exposure, according to one or more embodiments. Process 1100 begins by starting RGB frame exposure when IR frame exposure is in shutter mode 1101. Process 1100 continues by starting IR frame exposure and closing the shutter gate 1102 (TGAB). Process 1100 continues with a global transfer of the IR channel signal to in-pixel capacitors 1103 (C1, C2). Process 1100 continues with the global transfer of RGB channel signal to in-pixel capacitors, followed by full frame readout 1104.

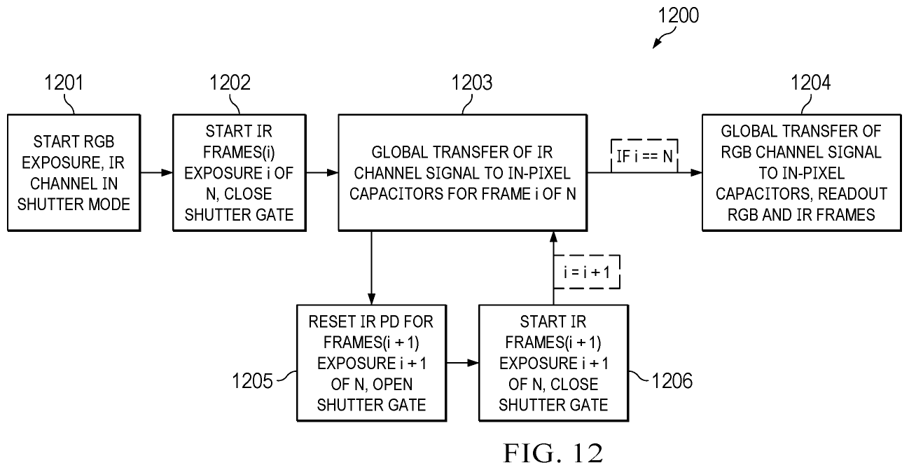

FIG. 12 is a flow diagram of a process 1200 for a combined readout of a RGB single frame exposure and multiple IR frame exposures, according to one or more embodiments. Process 1200 begins with RGB frame exposure when the IR channel is in shutter mode 1201. Process 1200 continues starting IR exposure of i to N frames while the shutter gate is closed 1202. Process 1200 continues with global transfer 1203 of the IR channel signal to in-pixel capacitors (C1, C2) for frame i of N (1203). Process 1200 continues by resetting the IR PD 1205 for frames (i+1) exposure i+1 of N while the shutter gate is open and starting IR frames (i+1) exposure i+1 of N while the shutter gate is closed 1206. When i=N, RGB channel signal is globally transferred to the in-pixel capacitors and the RGB and IR frames are read out 1204.

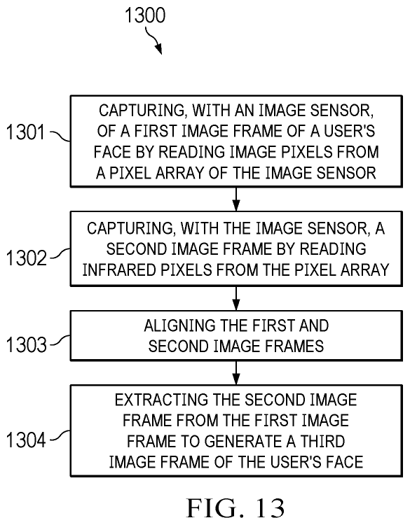

FIG. 13 is a flow diagram of a process 1300 of enhanced face ID using an RGBIR camera module of FIG. 1, according to one or more embodiments. Process 13 includes: capturing, with an image sensor, a first frame of a user's face by reading image pixels from a pixel array of the image sensor (1301); capturing, with the image sensor, a second frame by reading infrared pixels from the pixel array (1302); aligning the first and second frames (1303); and subtracting the second frame from the first frame to generate a third frame of the user's face (1304). Each of the foregoing steps was previously described in reference to FIG. 2.

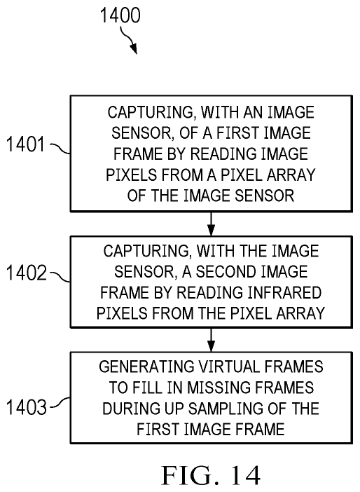

FIG. 14 is a flow diagram of a process 1400 of low light image enhancement using an RGBIR camera module, according to one or more embodiments. Process 14 includes: capturing, with an image sensor, a first frame by reading image pixels from a pixel array of the image sensor (1401); capturing, with the image sensor, a second frame by reading infrared pixels from the pixel array (1402); and generating virtual frames to fill in missing frames during up sampling of the first frame (1403). Each of the foregoing steps was previously described above in reference to FIG. 3.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A camera module comprising:
an image sensor comprising:
a microlens array;
a color filter array (CFA) comprising a red filter, a blue filter, a green filter and at least one infrared (IR) filter; and
a pixel array comprising pixels to convert light received through the color filter array into electrical signals; and
an image signal processor (ISP) configured to:
initiate capture of a first frame by reading signal pixels from the pixel array;
initiate capture of a second frame by reading IR pixels from the pixel array;
align the first and second frames; and
extract the second frame from the first frame to generate a third enhanced frame.

2. The camera module of claim 1, wherein the second image is extracted from the first frame only when the ISP determines that the camera module is being operated outdoors or indoors where lighting has IR content.

3. The camera module of claim 2, wherein the ISP determines that the camera module is being operated outdoors based on a face identification receiver output or an ambient light sensor with IR channels.

4. The camera module of claim 2, wherein output of an ambient light sensor is used to identify indoor IR noise.

5. The camera module of claim 1, wherein the image sensor is a rolling shutter image sensor.

6. The camera module of claim 1, wherein the image sensor is running in a secondary inter-frame readout (SIFR) mode.

7. The camera module of claim 1, wherein the first frame is captured with a first exposure time and the second frame is captured with a second exposure time that is shorter than the first exposure time.

8. The camera module of claim 1, wherein the second frame is captured while operating in an IR flood mode.

9. A camera module comprising:
an image sensor comprising:
a microlens array;
a color filter array (CFA) comprising a red filter, a blue filter, a green filter and at least one infrared (IR) filter; and
a pixel array comprising pixels to convert light received through the color filter array into electrical signals; and
an image signal processor (ISP) configured to:
initiate capture of a first frame by reading signal pixels from the pixel array;
initiate capture of a second frame by reading IR pixels from the pixel array; and
generating virtual frames to fill in missing frames during up sampling of the first frame.

10. The camera module of claim 9, wherein the image sensor is running in an adaptive frame rate exposure mode when the virtual frames are generated.

11. The camera module of claim 10, wherein when operating in the adaptive frame rate exposure mode, signal pixel and IR pixel data are time-multiplexed and configured to be read at different frames and exposure times.

12. A method comprising:
capturing, with an image sensor, of a first frame of a user's face by reading image pixels from a pixel array of the image sensor;
capturing, with the image sensor, a second frame by reading infrared (IR) pixels from the pixel array; and
extracting the second frame from the first frame to generate a third frame of the user's face.

13. The method of claim 12, further comprising authenticating the user based at least in part on the enhanced third frame of the user's face.

14. The method of claim 12, wherein the extracting is only performed outdoors.

15. The method of claim 12, wherein the second image is captured using a rolling shutter pixel architecture.

16. The method of claim 12, wherein the second frame is captured while operating in an IR flood mode.

17. A method comprising:
capturing, with an image sensor, of a first frame by reading image pixels from a pixel array of the image sensor;
capturing, with the image sensor, a second frame by reading infrared pixels from the pixel array; and
generating virtual frames to fill in missing frames during up sampling of the first frame.

18. The method of claim 17, wherein the image sensor is running in an adaptive frame rate exposure mode when the virtual frames are generated.

19. The method of claim 18, wherein when operating in the adaptive frame rate exposure mode, signal pixel and IR pixel data are time-multiplexed and configured to be read at different frames and exposure times.
